(19) United States
(12) Patent Application Publication
(10) Pub. No.: US 2006/0110554 A1
(43) Pub. Date: May 25, 2006

(54) Film comprising a gas barrier layer

(76) Inventors: Walter Bernig, Rettenberg (DE); Bernard Dujardin, Brussel (BE); Stefan Jendrosch, Ottobeuren (DE); Christoph Schweitzer, Obergunzenburg (DE)

Correspondence Address: PERMAN & GREEN, 425 POST ROAD, FAIRFIELD, CT, 06824, US

(21) Appl. No.: 10/523,130

(22) PCT Filed: Jul. 25, 2003
(86) PCT No.: PCT/EP03/08256

§ 371 Date: Aug. 24, 2005

(30) Foreign Application Priority Data
Jul. 30, 2002 (DE) 102 34 783.2

(51) Int. Cl. B32B 27/32

(52) U.S. Cl. 428/35.2; 428/34.8

(57) ABSTRACT

The invention relates to a single-layer or multilayer film made of at least one O₂ barrier layer that essentially consists of a mixture of ethylene vinyl alcohol copolymer (EVOH) and at least one multi polyamide, the use of the film for packaging perishable, gas-generating products such as food, and a packaging for perishable, gas-generating products, which is made of the film, particularly a cheese-aging bag.

The present invention relates to a plastics film which comprises at least one gas barrier layer substantially consisting of a mixture of ethylene/vinyl alcohol copolymer (EVOH) and at least one multipolyamide, to the use of this film for packaging perishable, gas-releasing products, such as foodstuffs, and to packaging for perishable, gas-releasing products, such as foodstuffs, in particular to a cheese ripening pouch made from this film.

Many perishable products, such as foodstuffs, are packaged in plastics films in order to protect them from environmental influences, such as oxygen and/or humidity, and so increase their storage life. These products sometimes continue to release gas during storage, as they are not yet completely mature at the time of packaging. For example, cheese microflora forms carbon dioxide during cheese ripening. A packaging material for perishable, gas-releasing products, in particular for foodstuffs, must accordingly exhibit not only low oxygen permeability but also sufficiently high carbon dioxide permeability. The intention here is to protect the product from oxygen from the outside while simultaneously releasing the carbon dioxide formed to the outside. Release of the CO₂ which forms into the surroundings from the packaging prevents the carbon dioxide from building up in the packaging and the packaging from bursting due to excessive pressure.

Perishable, gas-releasing foodstuffs frequently also contain moisture. For example, an incompletely ripened cheese is still moist after being treated with brine. A packaging material which is suitable for such a product with a variable moisture content should accordingly exhibit oxygen impermeability or carbon dioxide permeability which are largely independent of the particular moisture content of the packaged product or the surroundings.

In recent years, many plastics films have been developed for packaging perishable, gas-releasing products such as ripening cheese. There is, however, still a requirement for readily processable plastics films as a packaging material having the lowest possible oxygen permeability, which is largely independent of ambient humidity and/or the moisture content of the packaged product and having sufficient carbon dioxide permeability, which in the dry or the moist state is in each case a multiple of the oxygen permeability, such that it is possible largely to avert not only spoilage of the still ripening and thus gas-releasing foodstuff, such as cheese, but also the risk of a package bursting during the ripening process.

The object of the present invention was accordingly to provide a plastics film having the lowest possible oxygen permeability, which is largely independent of the moisture content of the packaged product and/or ambient humidity, and the carbon dioxide permeability to oxygen permeability ratio of which is ≧3:1.

According to the invention, this object is achieved by the provision of a plastics film which comprises at least one O₂ gas barrier layer substantially consisting of a mixture of an ethylene/vinyl alcohol copolymer (EVOH) and at least one multipolyamide or is produced therefrom, wherein the multipolyamide is made up of the 3 components
I. hexamethylenediamine/adipic acid (polyamide 6,6),
II. hexamethylenediamine/azelaic acid (polyamide 6,9) and/or hexamethylenediamine/sebacic acid (polyamide 6,10) and
III. hexamethylenediamine/isophthalic acid (polyamide 6,I) and/or hexamethylenediamine/terephthalic acid (polyamide 6,T).

The multipolyamide used for the production of the O₂ gas barrier layer is preferably made up of
a) 15-75 mol % of component I,
b) 15-55 mol % of component II and
c) 10-70 mol % of component III,
   wherein the total quantity of the components must always add up to 100 mol %.

A multipolyamide which is further preferred for the production of the O₂ gas barrier layer is one which is made up of
a) 50-60 mol % of component I,
b) 15-55 mol % of component II,
c) 10-45 mol % of component III,
   wherein the total quantity of the components must always add up to 100 mol %.

Very particularly preferably, the mixture from which the O₂ gas barrier layer is made up is produced using a multipolyamide which is made up of
a) 35-55 mol % of component I,
b) 15-55 mol % of component II and
c) 10-30 mol % of component III,
   wherein the total quantity of the components must always add up to 100 mol %.

The mixture of which the O₂ gas barrier layer substantially consists is preferably produced by using an ethylene/vinyl alcohol copolymer comprising 20-50 mol % ethylene, particularly preferably 42-48 mol % ethylene, very particularly preferably 38-48 mol % ethylene, which has been obtained by saponification of the corresponding ethylene/vinyl acetate copolymer.

The mixture which is used for the production of the O₂ gas barrier layer preferably consists of 10-45 wt. %, particularly preferably 20-40 wt. % EVOH and 55-90 wt. % or particularly preferably 60-80 wt. % of the above-described multipolyamide, wherein the total quantity of the two components must always add up to 100 wt. %. The two mixture components for the production of the mixture are preferably processed in conventional mixing units to form a polymer blend.

The film according to the invention preferably additionally comprises, apart from the O₂ gas barrier layer, at least 2 outer or surface layers, at least one of which should be heat-sealable.

The heat-sealing layer preferably contains the conventional polymers or mixtures used as a heat-sealing layer material selected from among the group comprising copolymers of ethylene and vinyl acetate, preferably with a content of vinyl acetate of at most 20 wt. %, relative to the total weight of the polymer, copolymers of ethylene and an ester of an α-, β-unsaturated carboxylic acid, such as butyl acrylate or ethyl acrylate, copolymers of ethylene and an α-, β-unsaturated carboxylic acid, such as acrylic acid, wherein the content of carboxylic acid preferably amounts to at most 15 wt. %, relative to the total weight of the copolymer, copolymers of ethylene and α-olefins with at least 3 C atoms such as butene, hexene, octene, 4-methyl-1-pentene (LLDPE=linear low density polyethylene), wherein the copolymer may be produced from ethylene and α-olefin with conventional catalysts or with metallocene catalysts and the density of the copolymer should be in the range from 0.915-0.93 g/cm³. VLDPE (very low density PE), which has a density of ≦0.915 g/cm³ is furthermore suitable as a heat-sealing layer material. A preferably used heat-sealing layer material is a mixture of 40-65 wt. % LLDPE and 35-60 wt. % ethylene/vinyl acetate copolymer, in each case relative to 100 wt. % of the polymer components.

Both the heat-sealing layer and the second outer or surface layer may contain conventional additives such as antiblocking, antistatic and/or slip agents. The second surface layer is produced using polymers which are used for the production of the heat-sealing layer, as stated above. The two outer or surface layers particularly preferably consist of the same polymer components, wherein the components may, however, be present in differing mixture ratios. The second outer or surface layer preferably comprises a layer material which consists of a mixture of 1-25 wt. % LLDPE and 99-75 wt. % of a copolymer of ethylene/vinyl acetate, in each case relative to 100 wt. % of the polymer components.

The film according to the invention is thus preferably of a multilayer structure, wherein, apart from the O₂ gas barrier layer, the film additionally comprises 2 surface or outer layers, one of which is heat-sealable and both outer layers are in each case preferably joined to the O₂ gas barrier layer via a coupling agent layer.

The material used for the coupling agent layer may preferably be a laminating adhesive based on polyurethanes or polyester urethanes or an extrudable polymer. A modified polyolefin is preferably used as an extrudable coupling agent. Such a polymer is preferably a polyolefin with carboxyl groups, such as for example polyethylene, polypropylene, an ethylene/α-olefin copolymer or an ethylene/vinyl acetate copolymer, which is in each case grafted at least with one monomer from the group of α-, β-monounsaturated dicarboxylic acids, such as for example maleic acid, fumaric acid, itaconic acid or the acid anhydrides, acid esters, acid amides or acid imides thereof. Extrudable coupling agent polymers which may additionally be used are copolymers of ethylene with α-, β-monounsaturated carboxylic acids such as acrylic acid, methacrylic acid or the metal salts thereof, such as zinc or sodium, and/or the alkyl(C₁-C₄) esters thereof or corresponding graft polymers onto polyolefins, such as for example polyethylene, polypropylene or ethylene/α-olefin copolymers which are graft polymerised a monomer of one of the stated unsaturated acids. Polyolefins with grafted α-, β-monounsaturated dicarboxylic anhydride, in particular a maleic anhydride-grafted ethylene/α-olefin copolymer or a grafted ethylene/vinyl acetate copolymer, preferably blended with m-LLDPE, are particularly preferred. Such a mixture may here comprise 40-60 wt. % LLDPE.

At least one of the coupling agent layers may be coloured, preferably with a colorant approved for food use.

The O₂ gas barrier layer according to the invention preferably has a thickness of at least 3 μm, particularly preferably of 4-10 μm. The optionally present outer layers, i.e. the surface layers, in each case have a thickness of 5-20 μm, preferably a thickness of 8-17 μm and the optionally present coupling agent layers in each case preferably have a thickness of 5-20 μm, preferably of 6-18 μm.

The single layer or multilayer film according to the invention may be produced using any known processes such as the film lamination, extrusion or blowing processes, preferably by a coextrusion blown film process.

The film is preferably at least monoaxially, particularly preferably biaxially, drawn, wherein it is endeavoured to obtain a draw ratio of 1:3 in both the longitudinal and transverse direction.

The film according to the invention is preferably shrinkable, it particularly preferably exhibits shrinkage in the longitudinal direction of at least 30%, preferably of at least 35%, and in the transverse direction of at least 35%, preferably of at least 38%, at a temperature of 90-100° C. To this end, at least one layer of the film according to the invention is crosslinked, preferably by irradiation or electron beam curing.

Because the multilayer film according to the invention preferably comprises outer layers with an elevated content of polyolefins, preferably polyethylene, it exhibits low water vapour permeability.

Since a ratio of oxygen permeability to carbon dioxide permeability of at least 1:3 and a low oxygen permeability are achieved with the film according to the invention, wherein oxygen permeability is largely independent of the moisture content of the packaged product and/or ambient humidity and the dry to moist value accordingly varies at most in the range 1:0.90 to 1:1.25, preferably 1:0.95 to 1:1.20, the film according to the invention is in particular suitable as a packaging material for gas-releasing foodstuffs.

The present invention accordingly also provides the use of the film according to the invention, preferably a multilayer film, for packaging perishable, gas-releasing products, preferably foodstuffs. The film according to the invention is particularly suitable for packaging cheese, preferably semi-hard and/or hard cheese, particularly preferably cheese which is still ripening.

The present invention also provides packaging for perishable, gas-releasing products, preferably foodstuffs, particularly preferably cheese which is still ripening, made from film the according to the invention.

The present invention accordingly also provides a cheese ripening pouch made from the film according to the invention, preferably a multilayer film.

The oxygen permeability of the film according to the invention is determined to ASTM D3985. To this end, one side of the film is exposed to oxygen under controlled conditions and the transmission rate to the other side of the film is measured.

The carbon dioxide permeability of the film is determined analogously to ASTM D3985.

Both oxygen and carbon dioxide permeability are determined at differing ambient humidity levels.

The gas permeability measurements at a relative humidity of 85% were performed with an Ox-Tran Twin instrument from Mocon, while the measurements at a relative humidity of 0% were performed with an L100 instrument from Lissy.

The values for O₂ and CO₂ gas permeability of a gas barrier layer consisting of only one polymer component of the O₂ gas barrier layer according to the invention and of an O₂ barrier layer according to the invention at a relative humidity of 0% and of 85% are shown in Tables 1A and 1B respectively.

TABLE 1A

| | | Gas permeability in ml/m² × d × bar, Brugger method | | | | | | | |
|---|---|---|---|---|---|---|---|---|---|
| | | 23° C.; 0% rel. | | 23° C., 85% rel. | | | | | |
| | Layer | humidity (dry) | | humidity (moist) | | O₂:CO₂ | | O₂ | CO₂ |
| Layer material | thickness | O₂ | CO₂ | O₂ | CO₂ | dry | moist | dry/moist | dry/moist |
| Multipolyamide* | 50.0μ | 41 | 128 | 28 | 294 | 1:3.15 | 1:10.4 | 1:1.4 | 1:0.4 |
| EVOH with 44 mol % ethylene | | | | | | | | | |
| Multipolyamide* (70% wt. %) & EVOH | 6.0μ | 152 | 481 | 150 | 959 | 1:3.21 | 1:6.4 | 1:1.0 | 1:0.5 |
| (30 wt. %) | | | | | | | | | |

TABLE 1B

| | | Specific gas permeability (Brugger | | | | | | | |
|---|---|---|---|---|---|---|---|---|---|
| | | value × layer thickness) ml/m² × d × bar | | | | | | | |
| Multipolyamide* | 50μ | 2050 | 6406 | 1400 | 14700 | 1:3.2 | 1:10.4 | 1:1.4 | 1:0.4 |
| Multipolyamide* (70% wt. %) & EVOH | 6μ | 901 | 2863 | 891 | 5708 | 1:3.2 | 1:6.4 | 1:1.01 | 1:0.5 |
| (30 wt. %) | | | | | | | | | |

Multipolyamide* = polyamide BM17SBG from EMS-Chemie AG (Switzerland)

### EXAMPLE 1

A film according to the invention with the following layer structure:
a) an outer layer,
b) a coupling agent layer,
c) an O₂ barrier layer,
d) a coupling agent layer and
e) a heat-sealing layer as an outer layer,
   was produced by the coextrusion blown film process and was drawn 1:3.3 in the longitudinal direction and 1:3.5 in the transverse direction.

Total film thickness was 55 μm. The thicknesses of the individual layers were: 10 μm for the outer layer a), 8 μm for the coupling agent layer b), 6 μm for the O₂ gas barrier layer c), 16 μm for the coupling agent layer d) and 15 μm for the heat-sealing layer e).

The materials used for the individual layers were:
for the outer layer a) a mixture of 56 wt. % of an EVA, 40 wt. % LLDPE and 4 wt. % antiblocking agent,
for the coupling agent layer b) a mixture of 50 wt. % of a maleic anhydride-modified EVA and 50 wt. % LLDPE,
for the O₂-barrier layer c) a mixture of EVOH with 44 mol % ethylene and a multipolyamide in a ratio by weight of EVOH to multipolyamide of 30:70,
for the coupling agent layer d) a mixture of 50 wt. % of a maleic anhydride-modified EVA and 50 wt. % LLDPE,
for the heat-sealing layer e) a mixture of 78 wt. % EVA, 20 wt. % LLDPE and 2 wt. % antiblocking agent and slip agent.

The O₂ gas permeability values of the film according to the invention at a relative humidity of 0% and of 85% are shown in Table 2, wherein the measurements were performed in accordance with the above-stated information.

The gas permeability measurements at a relative humidity of 85% were performed with an Ox-Tran Twin instrument from Mocon, while the measurements at a relative humidity of 0% were performed with an L100 instrument from Lissy.

TABLE 2

| Specific oxygen permeability | | |
|---|---|---|
| [ml/m² × d × bar] | | Specific carbon dioxide |
| Mixture of EVOH and | 30/70 | permeability [ml/m² × d × bar] |
| multipolyamide* | (wt. %) | 30:70 (wt. %) |
| 0% rel. humidity | 644 | 424 × 5.5 |
| 85% rel. humidity | 544 | 888 × 5.5 |

Multipolyamide* = polyamide BM17SBG from EMS-Chemie AG (Switzerland)

1. A film comprising at least one O₂ gas barrier layer substantially consisting of a mixture of an ethylene/vinyl alcohol copolymer (EVOH) and at least one multipolyamide, wherein the multipolyamide is made up of the 3 components
I) hexamethylenediamine/adipic acid (polyamide 6,6),
II) hexamethylenediamine/azelaic acid (polyamide 6,9) and/or hexamethylenediamine/sebacic acid (polyamide 6,10) and
III) hexamethylenediamine/isophthalic acid (polyamide 6,I) and/or hexamethylenediamine/terephthalic acid (polyamide 6,T).

2. A film according to claim 1, characterised in that the multipolyamide is made up of
a) 15-75 mol % of component I,
b) 15-65 mol % of component II and
c) 10-70 mol % of component III,
wherein the total quantity of components I-III must always add up to 100 mol %.

3. A film according to claim 1, characterised in that the multipolyamide is made up of
a) 15-60 mol % of component I,
b) 15-55 mol % of component II and
c) 10-45 mol % of component III,
wherein the total quantity of components I-III must always add up to 100 mol %.

4. A film according to claim 1, characterised in that the multipolyamide is made up of
a) 35-55 mol % of component I,
b) 15-55 mol % of component II and
c) 10-30 mol % of component III,
wherein the total quantity of components I-III must always add up to 100 mol %.

5. A film according to claim 1, characterised in that the ethylene/vinyl alcohol copolymer consists of 20-50 mol % ethylene, preferably 42-48 mol % ethylene, particularly preferably 38-48 mol % ethylene.

6. A film according to claim 1, characterised in that the O₂ gas barrier layer consists of a mixture of 10-45 wt. % EVOH and 55-90 wt. % multipolyamide, in each case relative to the total quantity of the mixture.

7. A film according to claim 6, characterised in that the O₂ gas barrier layer consists of a mixture of 20-40 wt. % EVOH and 60-80 wt. % multipolyamide, in each case relative to the total quantity of the mixture.

8. A film according to claim 1, containing at least one outer layer, preferably two outer or surface layers, at least one of which layers is heat-sealable.

9. A film according to claim 8, characterised in that a mixture of ethylene/vinyl acetate copolymer (EVA) and LLDPE (linear low density polyethylene) is used as the outer layer material.

10. A film according to claim 9, characterised in that a mixture of 40-65 wt. % of an ethylene/vinyl acetate copolymer and 35-60 wt. % of LLDPE, wherein the total quantity of the polymer components must always add up to 100 wt. %, is used as the heat-sealing layer material.

11. A multilayer film according to claim 1, characterised in that it is made up of the O₂ gas barrier layer and 2 outer layers.

12. A film according to claim 11, characterised in that the layers are in each case joined together by a coupling agent layer.

13. A film according to claim 12, characterised in that the coupling agent layers are based on a mixture of maleic anhydride-grafted ethylene/vinyl acetate copolymer and LLDPE.

14. A film according to claim 12, characterised in that at least one coupling agent layer is coloured.

15. A film according to claim 1, characterised in that the film is monoaxially, preferably biaxially, drawn.

16. A film according to claim 1, characterised in that the film comprises at least one crosslinked layer.

17. A film according to claim 1, characterised in that the film is shrinkable.

18. Use of a film according to claim 1 for packaging perishable, gas-releasing products, preferably foodstuffs.

19. Use according to claim 19 for packaging cheese, preferably cheese which is still ripening.

20. Use according to claim 19 for packaging semi-hard and/or hard cheese.

21. Packaging for perishable, gas-releasing products, preferably foodstuffs, made from a film according to claim 1.

22. Packaging for cheese made from a film according to claim 1.

23. A cheese ripening pouch made from a film according to claim 1.
